(19) United States
(12) Patent Application Publication
(10) Pub. No.: US 2009/0299842 A1
(43) Pub. Date: Dec. 3, 2009

(54) Nobel auction house coins

(76) Inventor: Peter Chao, San Francisco, CA (US)

Correspondence Address: Peter Y. Chao, Esq., 807 Montgomery Street, San Francisco, CA, 93133, US

(21) Appl. No.: 12/156,347

(22) Filed: Jun. 2, 2008

(51) Int. Cl. G06Q 30/00; G06Q 90/00

(52) U.S. Cl. 705/14.23; 705/14.4

(57) ABSTRACT

An improved advertising method which provides discounts for purchasers and sellers. One future embodiment of this coin is as a round shape with King's Head.

### CROSS-REFERENCE TO RELATED APPLICATIONS

This application is an advertising process of the Nobel Auction House, filed by Peter Chao.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable

### BACKGROUND OF THE INVENTION

(a) This invention relates to an advertising process of the Nobel Auction House, it is an award or a discount to both buyers and sellers.
(b) Normally, internet auction marketplaces only provide awards or discounts to purchasers.

### BRIEF SUMMARY OF THE INVENTION

In cyberspace the Nobel Auction House coin is a credit awarded to both buyers and sellers and does not physically exist. In the future, it is anticipated that an actual coin will be produced.

### BRIEF DESCRIPTION OF THE SEVERAL VIEWS OF THE DRAWINGS

Since the coin does not actually exist yet there is presently no design. However, it will look something like:

FIG. 1 is the Nobel Auction House Coin

### DETAILED DESCRIPTION OF THE INVENTION

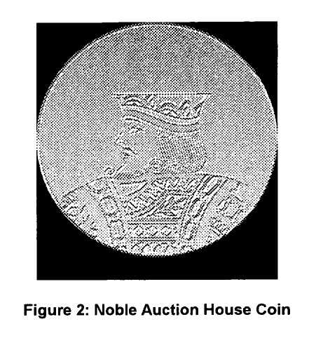

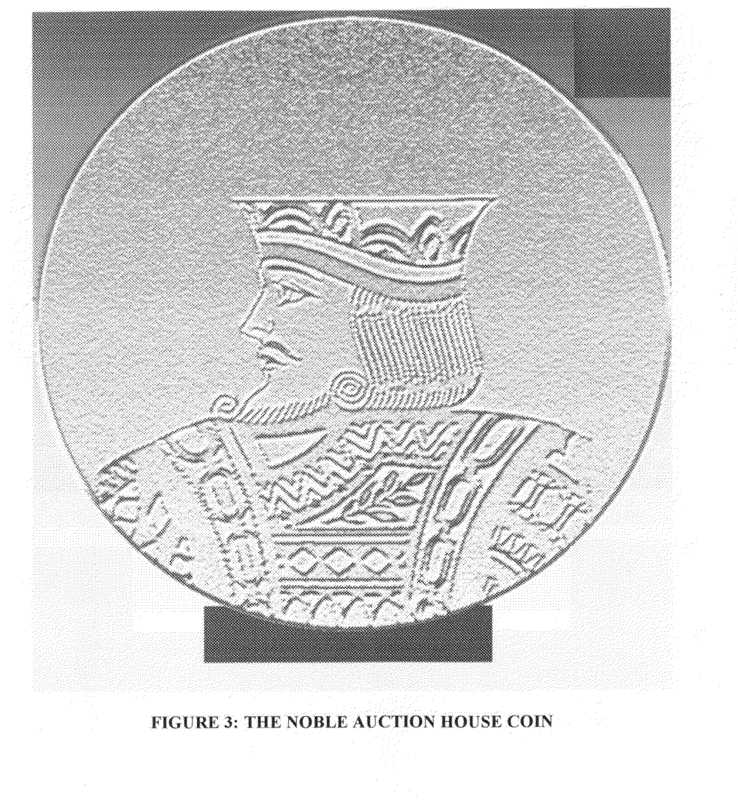

(a) Static Description of Figures
One embodiment of the Nobel Auction House Coin is illustrated in FIG. 1. The closure has a round shape with a King's head.

(b) Operational Description of Figure
The Nobel Auction House offers a coin on every purchase or sale to users through their auction website. By earning a coin and using it saves up to 10% off their next purchase.

(c) Advantages
From the description above, there are a number of advantages to the Nobel Auction House Coin:
(1) Nobel Auction House Coin can be used and combined with cash to purchase items in the auction.
(2) Both purchasers and sellers can use this coin.
(3) The Nobel Auction House Coin allows Peter Chao to create his own market since the coin can only be used on his website.

(d) Conclusion, Ramifications, and Scope
While the above description contains many details, these details should not be construed as limitations on the scope of any embodiment, but as an example of the presently preferred embodiments thereof Many other ramifications and variations are possible within the various embodiments. For example, the coin presently has no physical existence but it is anticipated that an actual coin be made in the future.
Thus the scope of the invention should be determined by legal equivalents, and not by the example given.

1. A process of advertising the Noble Auction House, comprising of
(a) creating a cyberspace coin allows a buyer or seller to earn discounts after an auction on the Noble House website
(b) having a coin allows said buyer or seller the right to use the coin on the Noble Auction website.
(c) having a coin allows Noble House to create their own market since the coin cannot be used elsewhere.
